(19) United States
(12) Patent Application Publication
(10) Pub. No.: US 2015/0227962 A1
(43) Pub. Date: Aug. 13, 2015

(54) A/B TESTING AND VISUALIZATION

(71) Applicant: Sears Brands, L.L.C., Hoffman Estates, IL (US)

(72) Inventors: Kelly Joseph Wical, Arlington Heights, IL (US); Tal Kedar, Chicago, IL (US)

(73) Assignee: Sears Brands, L.L.C., Hoffman Estates, IL (US)

(21) Appl. No.: 14/177,959

(22) Filed: Feb. 11, 2014

(51) Int. Cl. G06Q 30/02

(52) U.S. Cl. CPC G06Q 30/0243

(57) ABSTRACT

A/B testing methods, apparatus, systems and presentations of A/B testing results are disclosed. An A/B testing method may include presenting a first version and second version under test to first and second groups of customers. The method may further include collecting, during a first test period, data based on responses to the first and second versions under test, and determining, based on data collected during the first test period, a probability representative of a likelihood that the second version outperforms the first version. The method may also include calculating an estimate for a second test period over which additional data regarding responses to the first and second version is to be collected before the likelihood that the second version outperforms the first version has a predetermined relationship to a target probability.

### FIELD OF THE INVENTION

Various embodiments relate to electronic commerce (e-commerce), and more particularly, to A/B testing of e-commerce sites and visualizing results obtained via A/B testing.

### BACKGROUND OF THE INVENTION

Electronic commerce (e-commerce) websites or sites are an increasingly popular venue for consumers to research and purchase products without physically visiting a conventional brick-and-mortar retail store. An e-commerce site may provide products and/or services to a vast number of customers. As a result, an e-commerce site may serve customers having a wide range of different economic, social, and other factors. In attempts to better serve such a diverse customer base, an e-commerce site may utilize A/B testing to ascertain changes that may result in a more useful site for its customer base. A/B testing generally involves testing two variants or versions, A and B, to determine which version performs better. In particular, A/B testing may identify changes that increase or maximize an outcome of interest (e.g., click-through rate for a banner advertisement). As the name implies, two versions (A and B) are compared, which differ in at least one aspect believed to impact user behavior. Version A may correspond to the currently used version, while version B may correspond to a version proposed to replace version A and which is modified in some respect to version A.

As a result of A/B testing, an e-commerce site may collect data regarding customer responses to and usage of the two versions. The collected data may provide decision makers (e.g., store managers, board members) with insights into changes that may have a beneficial impact. However, decision makers may have a difficult time accurately assessing the collected data, especially if the decision makers do not have an adequate background in statistics. Moreover, an A/B test may need to run for an extended period of time before conventional A/B testing methods are able to provide useful results. Such a delay in obtaining useful results may reduce the effectiveness of the tested change since general distribution of an ultimately determined beneficial change is likewise delayed.

Limitations and disadvantages of conventional and traditional approaches should become apparent to one of skill in the art, through comparison of such systems with aspects of the present invention as set forth in the remainder of the present application.

### BRIEF SUMMARY OF THE INVENTION

Apparatus and methods of A/B testing and presenting the results of such A/B testing are substantially shown in and/or described in connection with at least one of the figures, and are set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 shows an example e-commerce environment comprising computing devices and an e-commerce system in accordance with an embodiment of the present invention.

FIG. 2 shows aspects regarding customer profiles and a product catalog maintained by the example e-commerce system of FIG. 1.

FIG. 3 shows a flowchart for an embodiment of an A/B testing method that may be used by the e-commerce system of FIG. 1.

FIG. 4 shows a graphical depiction that compares performance of two versions with the e-commerce system of FIG. 1 is testing.

FIG. 5 shows an example presentation of A/B testing results that may be generated by the e-commerce system of FIG. 1.

FIG. 6 shows an example computing device that may be used to implement one or more computing devices of the e-commerce environment depicted in FIG. 1.

FIG. 7A-7D shows an example listing of a function that may be used by the e-commerce system of FIG. 1 to measure the efficacy of each version under test.

### DETAILED DESCRIPTION OF THE INVENTION

Aspects of the present invention are related to A/B testing and presentation of A/B testing results. More specifically, certain embodiments of the present invention relate to apparatus, hardware and/or software systems, and associated methods that present to customers and potential customers two versions of a site, portions of a site, promotional materials for a site, etc., collect data regarding the response to the two versions, and present the collected data to decision makers in a manner that permits the decision makers to make informed decisions regarding which of the two versions to use in the future.

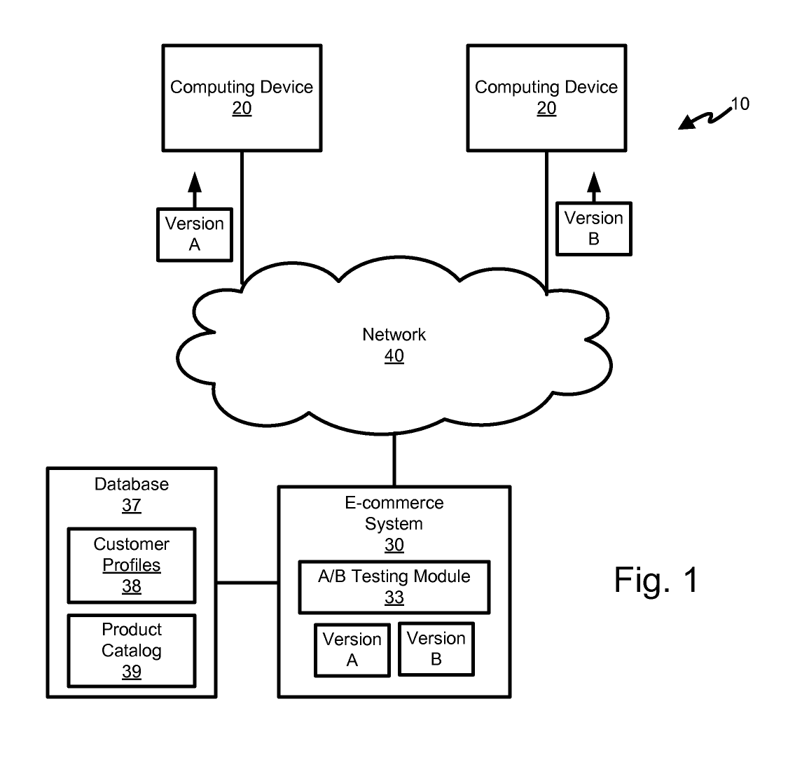

Referring now to FIG. 1, an e-commerce environment 10 is depicted. As shown, the e-commerce environment 10 may include computing devices 20 connected to an e-commerce system 30 via a network 40. The network 40 may include a number of private and/or public networks such as, for example, wireless and/or wired LAN networks, cellular networks, and the Internet that collectively provide a communication path and/or paths between the computing devices 20 and the e-commerce system 30. Each computing devices 20 may include a desktop, a laptop, a tablet, a smart phone, and/or some other type of computing device which enables a user to communicate with the e-commerce system 30 via the network 40. The e-commerce system 30 may include one or more web servers, database servers, routers, load balancers, and/or other computing and/or networking devices that operate to provide an e-commerce experience for users that connect to the e-commerce system 30 via computing devices 20 and the network 40.

The e-commerce system 30 may further include one more A/B testing modules 33 configured to conduct one or more A/B tests. In particular, the A/B testing modules 33 may include software, firmware, and/or hardware that enable the e-commerce system 30 to conduct A/B testing. To this end, the A/B testing module 33 may ensure a first group of customers (Group A) receive a first version (Version A) of an item being tested and a second group of customers (Group B) receives a second version (Version B) of an item being tested.

As a matter of convenience, the follow description identifies actions performed by the A/B testing module 33. However, for embodiments in which the A/B testing module 33 is implemented as software and/or firmware, one skilled in the art appreciates that such software and/or firmware do not in fact perform the respective action, but instead hardware (e.g., a processor) performs such actions as a result of executing the respective software and/or firmware.

The items being tested by the A/B testing module 33 may be selected from a vast array of items. For example, the selected item under test may correspond to a promotional offer, a reward program offer, a merchandise discount, a coupon, and/or an advertisement delivered to the customers via mail, email, internal communication systems of the e-commerce system, social media outlets, forums, and/or other forms of communications. The selected item under test may correspond to “improved” functionality of the site provided by the e-commerce system 30 such as, for example, an updated and/or new virtual shopping features, social features, checkout features, etc. The item may also correspond to an e-commerce site update that includes changes to content, layout, and/or organization of the web pages presented to customer. In each of these tests, the A/B testing module includes both an A version and a B version of the item to be tested.

The e-commerce system 30 may enable customers to browse for and/or otherwise locate products of interest. The e-commerce system 30 may further enable such customers to purchase products of interest. To this end, the e-commerce system 30 may maintain customer profiles 38 and a product catalog 39 stored in an associated electronic database 37 of the e-commerce system 30.

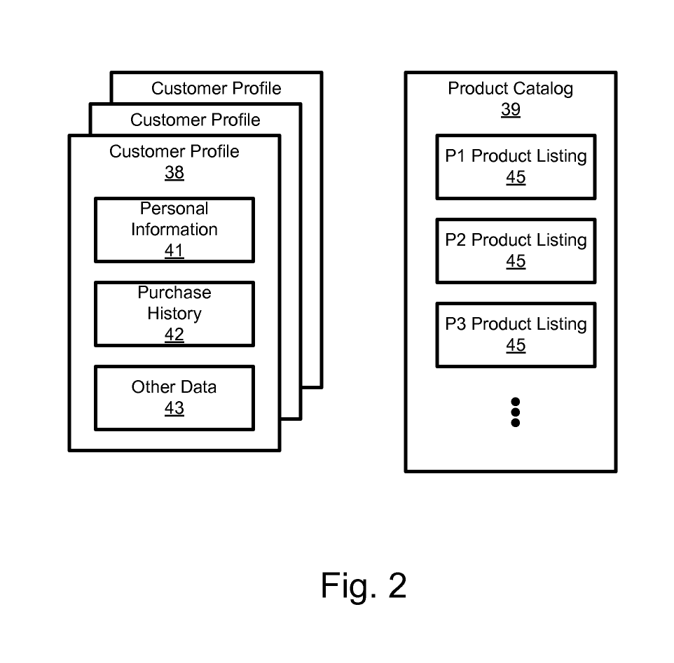

As shown in FIG. 2, a customer profile 38 may include personal information 41, purchase history data 42, and possible other data 43 for the associated customer. The personal information 41 may include such items as name, mailing address, email address, phone number, billing information, clothing sizes, birthdates of friends and family, etc. The purchase history data 42 may include information regarding products previously purchased by the customer from the e-commerce system 30. The other data 43 may include information regarding prior customer activities such as products for which the customer has previously searched, products for which the customer has previously viewed, products for which the customer has provide comments, products for which the customer has rated, products for which the customer has written reviews, etc. and/or purchased from the e-commerce system 30.

As shown in FIG. 2, the product catalog 39 may include product listings 45 for each product available for purchase. Each product listing 45 may include various information or attributes regarding the respective product, such as a unique product identifier (e.g., stock-keeping unit “SKU”), a product description, product image(s), manufacture information, available quantity, price, product features, etc.

As noted above, the e-commerce system 30 may include an A/B testing module 33 that is configured to conduct an A/B test. In the interest of providing further clarity, the following describes an example process for conducting an A/B test. In particular, the following describes an example A/B test in which the e-commerce system 30 provides two versions of an e-commerce site and compares the performance of the two versions based on an average value per unique visitor over time metric. Further details of the example A/B test are presented below. However, it should be appreciated that the described A/B test is provided for illustrative purposes and that various aspects of the described A/B testing process may apply to A/B tests between versions of other items of interest for the e-commerce site. For example, the A/B testing module 33 may be used to test between two versions of an e-commerce site, two versions of a portion (e.g. welcome page, virtual shopping cart, checkout process, etc.) of an e-commerce site, two versions of promotional materials (e.g., coupons, reward programs, customer loyalty programs, discount programs, etc.) sent or otherwise presented to customers of the e-commerce site.

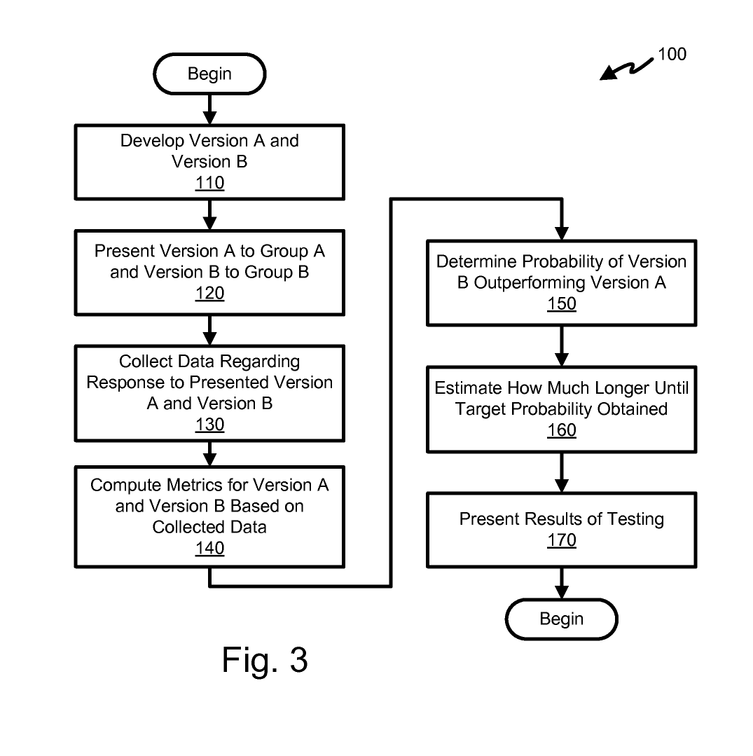

Referring now to FIG. 3, an example A/B testing method 100 that may be implemented by one of the A/B testing modules 33 is shown. At 110, the A/B testing module 33 may be configured to present two versions (e.g., Versions A and B) for testing. For example, web designers may have developed a new version (e.g., Version B) of the e-commerce site which includes new functionality, a new color scheme, a new layout, and/or some other change in comparison to the existing version (e.g., Version A) of the site.

The A/B testing module 33 at 120 may present Version A to a first group of customers (e.g., Group A) and present Version B to a second group of customers (e.g., Group B). In some embodiments, the A/B testing module 33 may present the versions with “stickiness” in which the same unique user is presented with the same version during multiple visits to the site during the testing period. For example, the A/B testing module 33 may ensure that a customer of Group A is presented with Version A and that a customer of Group B is presented with Version B during the testing period. To this end, the A/B testing module 33 may utilize information from customer profiles 38 to identify and assign customers to a respective Group A or B. However, it should be appreciated that other mechanisms may be used to ensure or make it highly likely that a particular customer is presented with the same version of the site during the testing period. For example, the A/B testing module 33 may split incoming requests based on a characteristic of the incoming request that is likely unique for a particular customer such as the Internet Protocol (IP) address that identifies the source of the incoming request.

At 130, the A/B testing module 33 may collect various data regarding the response the customers have to their respective version. In particular, the A/B testing module 33 may collect data in order to compute metrics for the versions under test. In the present example, the A/B testing module 33 may attempt to determine which version of the site generates more profit or revenue per unique customer. To this end, the A/B testing module 33 during the testing period may collect for each customer the revenue or profit generated by the customer during the testing period and store such collected data in the electronic database 37 for future retrieval and analysis.

The A/B testing module 33 at 140 may compute metrics for the versions in an attempt to determine which version has the better performance. In this particular example, the A/B testing module 33 computes an average value per unique visitor metric for each version. However, other metrics may be computed based on the goal of the A/B test and desired characteristics of the versions under test.

For example, an A/B testing module 33 may be implemented that compares the effectiveness of two versions of an advertisement sent to customers via email. An average value per unique customer metric may provide some insight for such an A/B test. However, if the goal of the A/B test is to determine which advertisement is most likely to attract customers to the site, then another metric may be more useful. For example, the A/B testing module 33 may collect data at 130 that identifies the number of customers that actually clicked-through a link in the advertisement. The A/B test module 33 may therefore use the clicked-through data to compute a click-through rate and may use such click-through rate to compare the effectiveness of the versions being tested.

As noted above, the A/B testing module 33 may compare the versions based on an average value per unique visitor confidence interval (auvv_ci). To this end, the A/B testing module 33 may compute an average value per unique visitor confidence interval based on auvv_ci function of Listing 1. In one embodiment, the auvv_ci function combines a conversion rate confidence interval (cvr_ci) computed using the cvr_ci function shown in Listing 2 and an average customer value confidence interval (acv_ci) computed using the acv_ci function shown in Listing 3. In particular, the auvv_ci function multiples the two minimums of the two intervals and the two maximums of the two intervals to obtain the confidence interval for the average value per unique visitor.

Note, all code listings are presented in the R programming language. The R programming language is a free software programming language and software environment for statistical computing and graphics. Moreover, the R programming language is widely used among statisticians and data miners.

Listing 1

auvv_ci <− function(n, values , conf.level) {

cvr <− cvr_ci(length(values), n, sqrt(conf.level))
acv <− acv_ci(values, sqrt(conf.level))
return(c(cvr[1]*acv[1], cvr[2]*acv[2]))

}

In Listing 1, the function parameter n represents the total number of unique visitors that came to the site during a time period TP. The function parameter values represents a vector of revenue or profit per unique visitor during the time period TP. The function parameter conf.level represents the desired confidence level. The expression length (values) represents the number of converted unique visitors and is used as the parameter k in the conversion rate confidence interval (cvr_ci) function shown in Listing 2. The auvv_ci function further uses the cvr_ci function as noted above and the average customer value confidence interval (acv_ci) function shown in Listing 3. The return value represents the two endpoints of the calculated confidence interval.

Listing 2

cvr_ci <− function(k, n, conf.level) {

interval <− binom.confint(k, n, conf.level=conf.level,

methods=“exact”)

return(c(interval$lower, interval$upper))

}

In Listing 2, the function cvr_ci calculates a conversion rate interval using the Clopper-Pearson “exact” method based on the supplied function parameters. In particular, the function parameter k represents the number of unique visitors that converted at least once (e.g., made at least one purchase) over the time period TP. The function parameter n represents the total number of unique visitors that came to the site over the time period TP. The function parameter conf.level represents the desired confidence level. The return value represents the two endpoints of the calculated confidence interval. The confint function from the binom package calculates a binomial confidence interval based on the parameters provided. The binom package may be obtained from the Comprehensive R Archive Network (CRAN).

Listing 3

acv_ci <− function(values , conf.level) {

return(t.test(values, conf.level=conf.level )$conf.int)

}

In Listing 3, the average customer value confidence interval (acv_ci) function uses the standard confidence interval for the mean of the Normal distribution with unknown variance. The function parameter values represents a vector revenue or profit per unique visitor over the time period TP. In one embodiment, the vector for the values parameter includes a single entry per unique visitor. Multiple orders by the same unique visitor over the time period TP are summed together. The function parameter conf.level represents the desired confidence level. The return value represents the two endpoints of the calculated confidence interval.

At 150, the A/B testing module 33 may determine, based on the metrics computed at 140, a probability of one version outperforming the other version. For example, the A/B testing module 33 at 150 may determine the probability of the new version (e.g., Version B) outperforming the existing version (e.g., Version A) via the compare (cmp) function shown in Listing 4.

Listing 4

cmp <− function(a.min, a.max, b.min, b.max) {

stopifnot(a.min < a.max, b.min < b.max)
if (a.max < b.min) {

return (1)

}
if (a.min > b.max) {

return (0)

}
u <− max(a.max, b.max) − min(a.min, b.min)
res <− (min(a.max, b.max) − max(a.min, b.min))/(2 * u)
if (b.max > a.max) {

res <− res + ((max(a.max, b.max) − min(a.max, b.max))/u)

}
if (a.min < b.min) {

res <− res + ((max(a.min, b.min) − min(a.min, b.min))/u)

}
return(res)

}

In Listing 4, the function parameters a.min, a.max, b.min, and b.max are the endpoints for the confidence intervals of for Versions A and B respectively. Moreover, the return value of the cmp function is a value between 0 and 1 that represent the probability of Version B outperforming Version A.

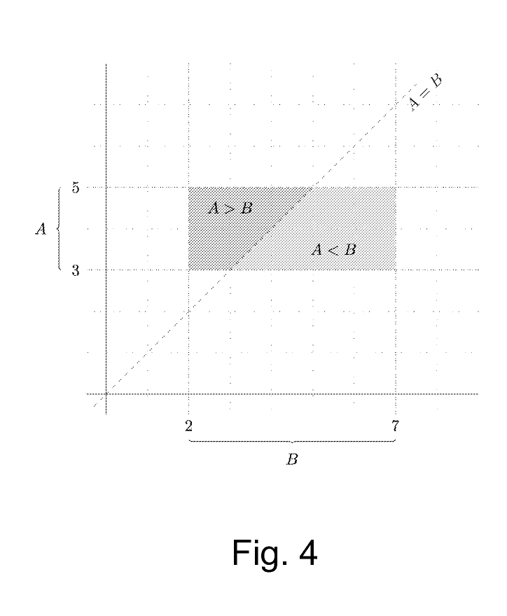

The computation of the cmp function is visually depicted in FIG. 4 for a confidence interval of [3, 5] for Version A and a confidence interval of [2, 7] for Version B. The shaded rectangular region of FIG. 4 represents all combinations for the performance of the two versions at the desired confidence level taking the values contained in the intervals to be equiprobable, namely that the combinations follow a uniform distribution. It should be appreciated that if the true probability distribution is known or another distribution is known to be more accurate, the cmp function may be revised accordingly. However, in which case the graphical representation becomes slightly more cumbersome to depict and understand.

The area in the shaded rectangle above the 45 degree line represents the combinations of Version A that perform better than Version B. Similarly, the area in the shaded rectangle below the 45 degree line represents where Version B outperforms Version A, assuming higher numeric values for the calculated metrics are better. If the semantics of the calculated values in the intervals are “negative” (e.g., the number of complaints received), the interpretation of better/worse is thus reversed.

The cmp function thus determines the portion of the shaded rectangle below the 45 degree line to determine an approximation for the probability of Version B outperforming Version A. In the depicted example, 60% of the rectangle is below the 45 degree line. As such, FIG. 4 depicts a situation in which there is an approximately 60% chance that Version B outperforms version A.

Besides determining the probability of Version B outperforming Version A, the A/B testing module 33 at 160 may further estimate how much longer the A/B test likely needs to run before enough data is collected to ascertain that the likelihood, that one version outperforms the other version, satisfies a certain threshold or target probability. In one embodiment, the A/B testing module 33 may make such a determination via the time left (time_left) function shown in Listing 5.

Listing 5

time_left <− function(t, a.n, a.values, b.n, b.values, conf.level)

{
stopifnot(t > 0, threshold > 0, threshold < 1)
min <− 1
max <− 1
p <− Inf
repeat {

a.ci <− auvv_ci(n=(a.n * max), values=rep(x=a.values,

each=max), conf.level=conf.level)

b.ci <− auvv_ci(n=(b.n * max), values=rep(x=b.values,

each=max), conf.level=conf.level)

p <− cmp(a.min=a.ci[1], a.max=a.ci[2], b.min=b.ci[1],

b.max=b.ci[2])

if (p > threshold || p < (1 − threshold)) {

break

}
min <− max
max <− max * 2

}
if (max == 1) {

return(0)

}
mid <− max
repeat {

mid <− ceiling((max + min)/2)
if (mid == max) {

break

}
a.ci <− auvv_ci(n=(a.n * mid), values=rep(x=a.values,

each=mid), conf.level=conf.level)

b.ci <− auvv_ci(n=(b.n * mid), values=rep(x=b.values,

each=mid), conf.level=conf.level)

p <− cmp(a.min=a.ci[1], a.max=a.ci[2], b.min=b.ci[1],

b.max=b.ci[2])

if (p > threshold || p < (1 − threshold)) {

max <− mid

} else {

min <− mid

}

}
return((mid − 1) * t)

}

In Listing 5, the function parameter t represents the time period that the test has been running thus far. The function parameter t may be expressed using a desired granularity such as, for example, weeks, days, hours, etc. The function parameters a.n and b.n represent the number of unique visitors sent to Version A and Version B respectively during the time period t. The function parameters a.values and b.values represent vectors of revenue or profit per unique visitor over the time period t for Version A and Version B, respectively. The function parameter threshold represents the desired probability that one version outperforms the other version. The function parameter conf.level represents the desired confidence level. The return value of the time_left function represents an estimate of the number of additional time units until the threshold probability is achieved. The return value is expressed in the same time units as the function parameter t. The time_left function generate the estimate based on the assumption that the data gathered during the time period t is representative of both the nature and rate of the additional data to be received over the additional time units.

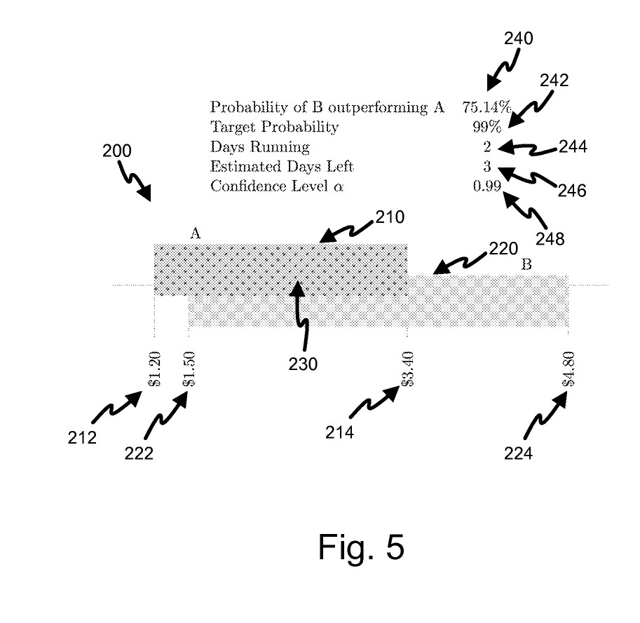

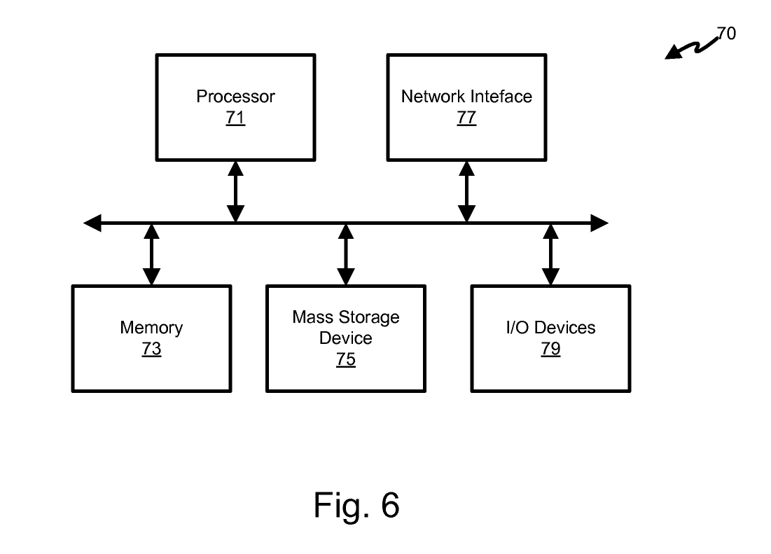

The A/B testing module 33 at 170 may further generate and present results of the A/B test. In particular, the A/B testing module 33 in one embodiment may generate and present the result in a manner similar to that shown in FIG. 5. In particular, the A/B testing module 33 may present the results as a webpage transferred to a computing device 20 via network 40 for display by such computing device 20. However, the presentation may take other forms such as a printed hardcopy report, an electronic presentation, a slide show, etc.

As shown, the presentation of the results may include a graphical depiction 200 of the confidence level metrics for both Version A and Version B. The graphical depiction may include a depiction 210 of the interval for Version A and a depiction 220 of the interval for Version B. Each depiction 210, 220 may show the lower endpoint 212, 222 and the upper endpoint 214, 224 of the respective interval. Moreover, the depictions 210, 220 may be presented along the same axis of a graph in a manner that provides a graphical depiction of an overlap 230 of the intervals. As shown, each interval depiction 210, 220 may be presented as a shaded rectangle. However, other embodiments may present the interval depictions 210, 220 in a different manner.

Besides the confidence level metrics for both Version A and Version B, the graphical depiction 200 may further include additional information. In particular, the A/B testing module 33 in one embodiment further provides a probability 240 of Version B outperforming Version A. Such a probability may be computed using the cmp function of Listing 4. The A/B testing module 33 may further provide a target probability 242, an indication 244 of the current duration of the A/B test, an estimate 246 as to how much longer the A/B test likely needs to run before the target probability 242 is obtained. Moreover, the A/B testing module 33 may identify the confidence level 248 used for the A/B test. As explained above, the estimate 246 may be calculated using the time_left function of Listing 5.

As noted above, the e-commerce environment 10 may include one or more computing devices. FIG. 5 depicts an embodiment of a computing device 70 suitable for the computing device 20 and/or the e-commerce system 30. As shown, the computing device 70 may include a processor 71, a memory 73, a mass storage device 75, a network interface 77, and various input/output (I/O) devices 79. The processor 71 may be configured to execute instructions, manipulate data and generally control operation of other components of the computing device 70 as a result of its execution. To this end, the processor 71 may include a general purpose processor such as an x86 processor or an ARM processor which are available from various vendors. However, the processor 71 may also be implemented using an application specific processor and/or other logic circuitry.

The memory 73 may store instructions and/or data to be executed and/or otherwise accessed by the processor 71. In some embodiments, the memory 73 may be completely and/or partially integrated with the processor 71.

In general, the mass storage device 75 may store software and/or firmware instructions which may be loaded in memory 73 and executed by processor 71. The mass storage device 75 may further store various types of data which the processor 71 may access, modify, and/otherwise manipulate in response to executing instructions from memory 73. To this end, the mass storage device 75 may comprise one or more redundant array of independent disks (RAID) devices, traditional hard disk drives (HDD), solid-state device (SSD) drives, flash memory devices, read only memory (ROM) devices, etc.

The network interface 77 may enable the computing device 70 to communicate with other computing devices directly and/or via network 40. To this end, the networking interface 77 may include a wired networking interface such as an Ethernet (IEEE 802.3) interface, a wireless networking interface such as a WiFi (IEEE 802.11) interface, a radio or mobile interface such as a cellular interface (GSM, CDMA, LTE, etc), and/or some other type of networking interface capable of providing a communications link between the computing device 70 and network 40 and/or another computing device.

Finally, the I/O devices 79 may generally provide devices which enable a user to interact with the computing device 70 by either receiving information from the computing device 70 and/or providing information to the computing device 70. For example, the I/O devices 79 may include display screens, keyboards, mice, touch screens, microphones, audio speakers, etc.

While the above provides general aspects of a computing device 70, those skilled in the art readily appreciate that there may be significant variation in actual implementations of a computing device. For example, a smart phone implementation of a computing device may use vastly different components and may have a vastly different architecture than a database server implementation of a computing device. However, despite such differences, computing devices generally include processors that execute software and/or firmware instructions in order to implement various functionality. As such, aspects of the present application may find utility across a vast array of different computing devices and the intention is not to limit the scope of the present application to a specific computing device and/or computing platform beyond any such limits that may be found in the appended claims.

Various embodiments of the invention have been described herein by way of example and not by way of limitation in the accompanying figures. For clarity of illustration, exemplary elements illustrated in the figures may not necessarily be drawn to scale. In this regard, for example, the dimensions of some of the elements may be exaggerated relative to other elements to provide clarity. Furthermore, where considered appropriate, reference labels have been repeated among the figures to indicate corresponding or analogous elements.

Moreover, certain embodiments may be implemented as a plurality of instructions on a non-transitory, computer readable storage medium such as, for example, flash memory devices, hard disk devices, compact disc media, DVD media, EEPROMs, etc. Such instructions, when executed by one or more computing devices, may result in the one or more computing devices implementing aspects of the A/B testing module 33 and/or other described aspects of the e-commerce system 30 and/or computing device 20.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope.

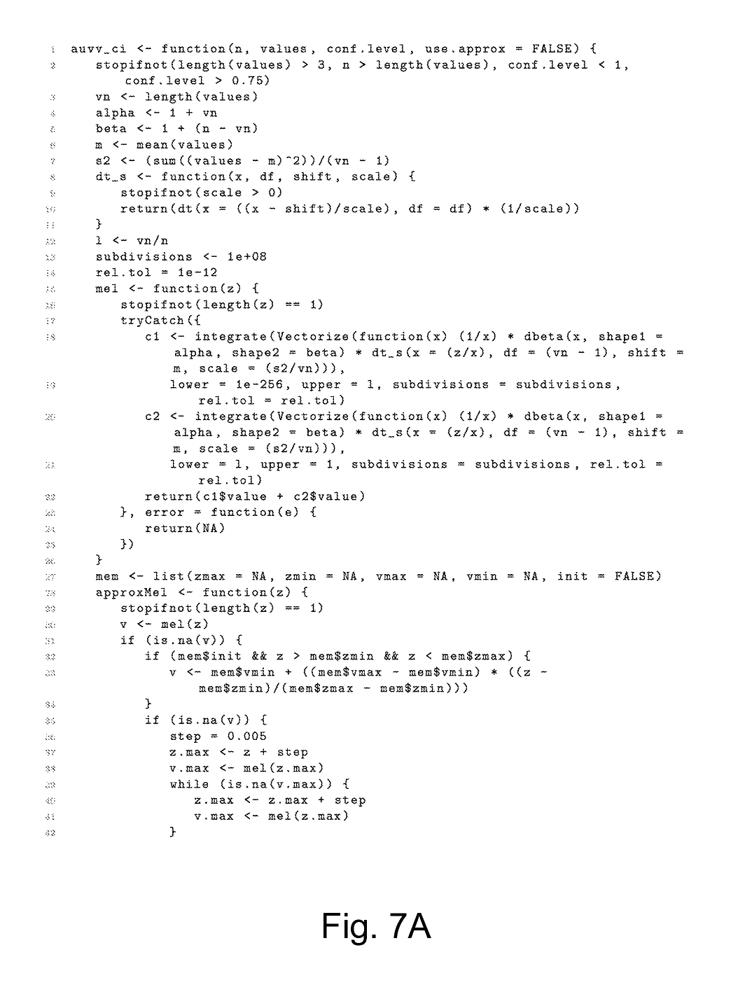

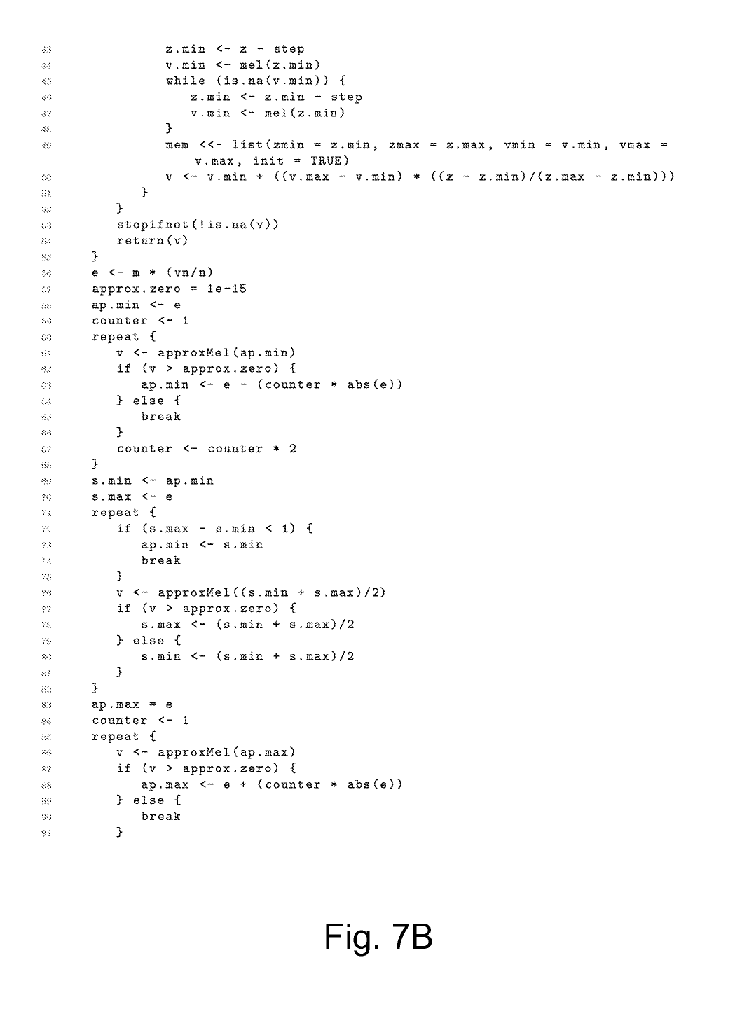

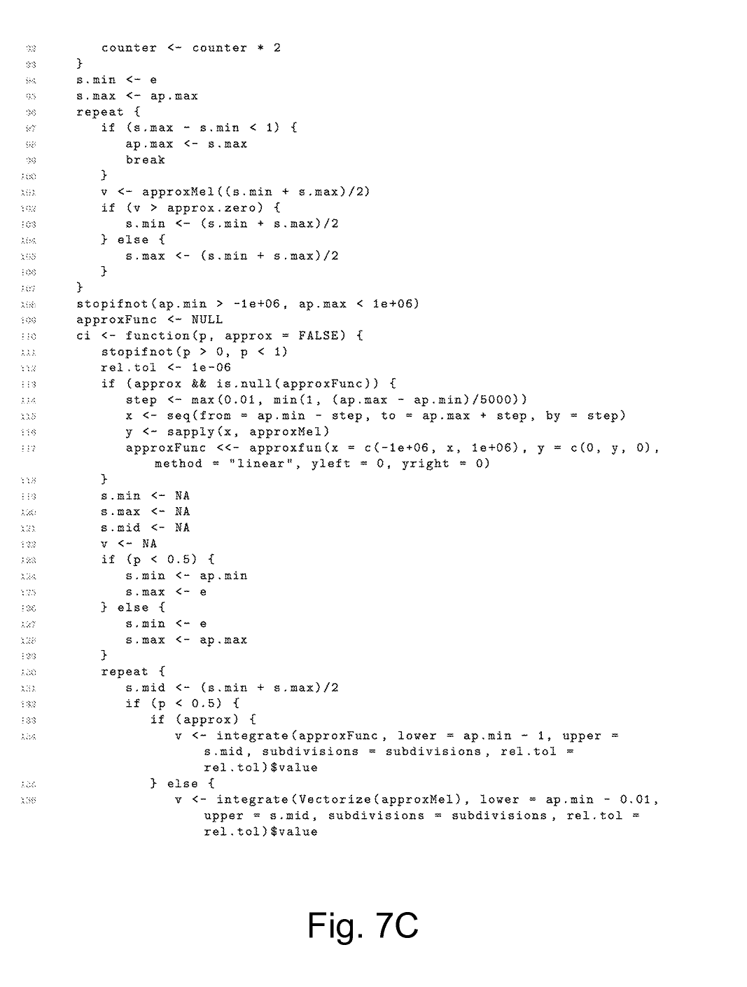

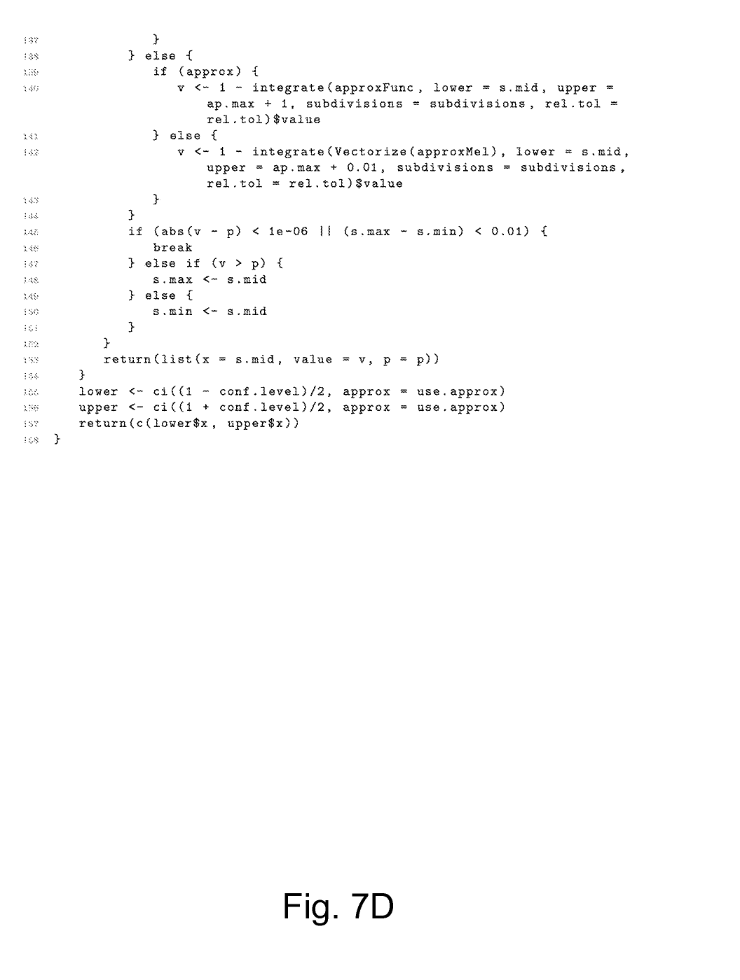

For example, example functions have been presented and shown in Listings 1-5. However, depending upon the nature of the A/B test involved such functions may be refined in order to possibly provide more accurate results. For example, an alternative function auvv_ci is presented in FIGS. 7A-7D which may be used instead of the functions presented in Listings 1-3 in order to calculate the average value per unique visitor confidence interval. The function of FIGS. 7A-7D calculates the confidence interval through Bayesian updates of flat priors for the conversion rate and the average customer value. The function then combines the two using a Mellin transform and numerically finds a central interval at the desired confidence level.

Therefore, it is intended that the present invention not be limited to the particular embodiment or embodiments disclosed, but that the present invention encompasses all embodiments falling within the scope of the appended claims.

What is claimed is:

1. A computer-implemented method, comprising:
presenting a first version under test to first computing devices for a first plurality of customers;
presenting a second version under test to second computing devices for a second plurality of customers;
collecting, during a first test period, data based on responses to the first version under test that are received via the first computing devices;
collecting, during the first test period, data based on responses to the second version under test that are received via the second computing devices; and
determining, based on data collected during the first test period, a probability representative of a likelihood that the second version outperforms the first version.

2. The computer-implemented method of claim 1 further comprising calculating an estimate for a second test period over which additional data regarding the responses to the first version and the second version is to be collected before the likelihood that the second version outperforms the first version has a predetermined relationship to a target probability.

3. The computer-implemented method of claim 2, further comprising presenting the determined probability and the calculated estimate for the second test period via a computing device.

4. The computer-implemented method of claim 1, wherein said determining the probability comprises:
determining a first confidence interval for the first version based on the collected data for the first version;
determining a second confidence interval for the second version based on the collected data for the second version; and
determining the probability based on first confidence interval and the second confidence interval.

5. The computer-implemented method of claim 4, further comprising presenting a graphical representation of the first confidence interval and the second confidence interval.

6. The computer-implemented method of claim 5, wherein the graphical representation graphically depicts an overlap of the first confidence interval and the second confidence interval overlap.

7. The computer-implemented method of claim 6, further comprising presenting the determined probability, the target probability, the calculated estimate for the second test period, and a desired confidence level.

8. A non-transitory computer-readable medium, comprising a plurality of instructions, that in response to being executed, result in a computing device:
presenting a first version under test and a second version under test respectively to a first plurality of customers and a second plurality of customers;
collecting, during a first test period, data based on responses to the first version under test and the second version under test; and
determining, based on data collected during the first test period, a probability representative of a likelihood that the second version outperforms the first version.

9. The non-transitory computer-readable medium of claim 8, wherein the plurality of instructions further result in the computing device calculating an estimate for a second test period over which additional data regarding the responses to the first version and the second version is to be collected before the likelihood that the second version outperforms the first version has a predetermined relationship to a target probability.

10. The non-transitory computer-readable medium of claim 9, wherein the plurality of instructions further result in the computing device presenting the determined probability and the calculated estimate.

11. The non-transitory computer-readable medium of claim 8, wherein the plurality of instructions further result in the computing device:
determining a first confidence interval for the first version based on the collected data for the first version;
determining a second confidence interval for the second version based on the collected data for the second version; and
determining the probability based on first confidence interval and the second confidence interval.

12. The non-transitory computer-readable medium of claim 11, wherein the plurality of instructions further result in the computing device:
determining, within a desired confidence level, a first conversion rate interval indicative of a rate first customers of the first plurality of customers made at least one purchase in response to the first version;
determining, within the desired confidence level, an average customer value interval for the first plurality of customers based on purchases of the first plurality of customers during the first test period; and
combining the first conversion rate interval and the average customer value interval to obtain, within the desired confidence level, an average value per unique customer interval for the first confidence interval.

13. The non-transitory computer-readable medium of claim 11, wherein the plurality of instructions further result in the computing device presenting a graphical representation of the first confidence interval and the second confidence interval.

14. The non-transitory computer-readable medium of claim 12, wherein:
the graphical representation graphically depicts an overlap of the first confidence interval and the second confidence interval overlap; and
the plurality of instructions further result in the computing device presenting the determined probability, the target probability, the calculated estimate for the second test period, and a desired confidence level.

15. An e-commerce system, comprising
an electronic database comprising a plurality of customer profiles and a product catalog; and
one or more computing devices configured to:
present, based on the customer profiles, a first version under test and a second version under test respectively to a first plurality of customers and a second plurality of customers;
collect, during a first test period, data based on responses to the first version under test and the second version under test; and
determine, based on data collected during the first test period, a probability representative of a likelihood that the second version outperforms the first version.

16. The e-commerce system of claim 15, wherein the one or more computing devices are further configured to calculate an estimate for a second test period over which additional data regarding the responses to the first version and the second version is to be collected before the likelihood that the second version outperforms the first version has a predetermined relationship to a target probability.

17. The e-commerce system of claim 16, wherein the one or more computing devices are further configured to generate a presentation of test results that includes the determined probability and the calculated estimate.

18. The e-commerce system of claim 15, wherein the one or more computing device are further configured to:
determine a first confidence interval for the first version based on the collected data for the first version;
determine a second confidence interval for the second version based on the collected data for the second version; and
determine the probability based on first confidence interval and the second confidence interval.

19. The e-commerce system of claim 18, wherein the one or more computing devices are further configured to generate a graphical representation of the first confidence interval and the second confidence interval such that the graphical representation graphically depicts an overlap of the first confidence interval and the second confidence interval overlap.

20. The e-commerce system of claim 19, wherein the one or more computing devices are further configured to generate a presentation of test results that includes the determined probability, the target probability, the calculated estimate for the second test period, and a desired confidence level.
